(19) United States
(12) Patent Application Publication
(10) Pub. No.: US 2023/0110261 A1
(43) Pub. Date: Apr. 13, 2023

(54) AEROSOL-GENERATION ARTICLE, ELECTRONIC VAPORIZER, VAPORIZATION SYSTEM, IDENTIFYING METHOD, AND TEMPERATURE CONTROL METHOD

(71) Applicant: Hainan Moore Brothers Technology Co., Ltd., Hainan (CN)

(72) Inventors: Zhenlong JIANG, Hainan (CN); Hengheng DOU, Hainan (CN); Congwen XIAO, Hainan (CN); Lingrong XIAO, Hainan (CN); Genchu TANG, Hainan (CN)

(21) Appl. No.: 17/955,037

(22) Filed: Sep. 28, 2022

(30) Foreign Application Priority Data
Oct. 8, 2021 (CN) 202111172472.1

(51) Int. Cl. A24F 40/46; A24F 40/57; A24F 40/51

(52) U.S. Cl. CPC A24F 40/46; A24F 40/51; A24F 40/57

(57) ABSTRACT

An aerosol-generation article includes: an aerosol-generation substrate; and a temperature sensor including a dielectric material whose dielectric constant changes with a temperature. A Curie temperature of the dielectric material falls with a temperature range required by the aerosol-generation substrate for forming aerosols. In an embodiment, the Curie temperature of the dielectric material ranges from 200° C. to 450° C.

### CROSS-REFERENCE TO PRIOR APPLICATION

Priority is claimed to Chinese Patent Application No. 202111172472.1, filed on Oct. 8, 2021, the entire disclosure of which is hereby incorporated by reference herein.

### FIELD

The present invention relates to the field of vaporization technologies, and in particular, to an aerosol-generation article, an electronic vaporizer, a vaporization system, a method for identifying a type of an aerosol-generation article, and a temperature control method.

### BACKGROUND

An electronic vaporizer is a device that mainly heats an aerosol-generation article to form aerosols. A low-temperature electronic vaporizer (or referred to as a heat-not-burn (HNB) device) is an electronic vaporizer that mainly bakes an aerosol-generation article at a low temperature of 200° C. to 450° C. to generate aerosols. Heating methods that can be used in the low-temperature electronic vaporizer mainly include central heating (a heating body is directly inserted into an aerosol-generation article to heat the aerosol-generation article) and circumferential heating (the aerosol-generation article is placed into a tubular heating body for heating). Because aerosols can be formed at a relatively low temperature without a large amount of harmful substances brought by high-temperature pyrolysis, the low-temperature electronic vaporizer is adored by people.

To prevent a temperature of the heating body from being excessively high to burn the aerosol-generation article close to the heating body and affect the taste of aerosols, a temperature sensor connected to a power source is mounted at a position (for example, a surface of a heating rod/pin or an inner side of a heating barrel) close to the heating body in a conventional electronic vaporizer, to implement temperature control. However, in the conventional electronic vaporizer, a space needs to be reserved for the temperature sensor in the electronic vaporizer, which is not beneficial to improving the structure design of the electronic vaporizer. In addition, the temperature sensor is arranged on a surface of the heating body, making the electronic vaporizer hard to clean.

### SUMMARY

In an embodiment, the present invention provides an aerosol-generation article, comprising: an aerosol-generation substrate; and a temperature sensor comprising a dielectric material whose dielectric constant changes with a temperature, wherein a Curie temperature of the dielectric material falls with a temperature range required by the aerosol-generation substrate for forming aerosols.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a vaporization system according to an embodiment;

FIG. 2 is a schematic cross-sectional view of an equivalent capacitor of the vaporization system shown in FIG. 1;

FIG. 3 is a schematic diagram of an equivalent capacitor according to another embodiment;

FIG. 4 is a schematic diagram of a plurality of equivalent capacitors according to another embodiment;

FIG. 5 is a schematic diagram of an equivalent capacitor according to another embodiment;

FIG. 6 is a schematic cross-sectional view of an equivalent capacitor and an electromagnetic shielding member according to another embodiment;

FIG. 7 is a schematic cross-sectional view of an equivalent capacitor and an electromagnetic shielding member according to another embodiment; and

FIG. 8 is a schematic diagram of a plurality of equivalent capacitors according to another embodiment. List of Reference Numerals:

### DETAILED DESCRIPTION

In an embodiment, the present invention provides an aerosol-generation article which is beneficial to structure optimization of an electronic vaporizer and facilitates cleaning of the electronic vaporizer.

In an embodiment, the present invention provides an electronic vaporizer which is easy to clean, a vaporization system, a method for identifying a type of an aerosol-generation article, and a temperature control method.

An aerosol-generation article is provided, including an aerosol-generation substrate and a temperature sensor, where the temperature sensor includes a dielectric material whose dielectric constant changes with a temperature, and a Curie temperature of the dielectric material falls with a temperature range required by the aerosol-generation substrate for forming aerosols.

The aerosol-generation article includes an aerosol-generation substrate and a temperature sensor. By using the temperature sensor as a part of the aerosol-generation article, a temperature of the aerosol-generation article can be measured while the temperature sensor is not in contact with an electronic vaporizer. Therefore, the electronic vaporizer is more convenient to clean, and no space needs to be reserved on the electronic vaporizer, thereby facilitating to improve the structure design of the electronic vaporizer. The Curie temperature of the dielectric material of the temperature sensor of the aerosol-generation article falls within the temperature range required by the aerosol-generation substrate for forming aerosols, so that the temperature sensor can be more sensitive to temperature changes, thereby improving the temperature measuring sensitivity.

In an embodiment, the Curie temperature of the dielectric material ranges from 200° C. to 450° C.

In an embodiment, the dielectric material is selected from at least one of niobate, zirconate, titanate, or bismuthate.

In an embodiment, the dielectric material is selected from at least one of NaNbO3, K0.5Na0.5NbO3, or 0.96K0.5Na0.5NbO3-0.04Bi0.5Na0.5ZrO3.

In an embodiment, the temperature sensor is in at least one form of a sheet, a pin, or a particle.

In an embodiment, the aerosol-generation article further includes a packaging layer; the aerosol-generation substrate is arranged in the packaging layer and is wrapped by the packaging layer; and the temperature sensor is arranged on an outer side of the packaging layer or the temperature sensor is arranged in the aerosol-generation substrate.

An electronic vaporizer is provided, including a first electrode, a second electrode, a detection module, a controller, and a heating module, where a cavity for accommodating an aerosol-generation article is formed between the first electrode and the second electrode, the detection module is configured to detect a dielectric constant of the aerosol-generation article accommodated in the cavity and feed back a detection result to the controller, and the controller controls power supply to the heating module according to the detection result.

In an embodiment, the first electrode, the aerosol-generation article accommodated in the cavity, and the second electrode form an equivalent capacitor; and the electronic vaporizer further includes an inductance coil, the inductance coil, the equivalent capacitor, and a power source form a resonance circuit, the detection module is configured to detect a resonance frequency of the resonance circuit, and the controller controls power supply of the power source to the heating module according to the resonance frequency.

In an embodiment, when a temperature corresponding to the detection result is lower than a preset cooling temperature, the controller controls a power source to supply normal power to the heating module; and when the temperature corresponding to the detection result is higher than or equal to the preset cooling temperature, the controller controls the power source to reduce power supply to the heating module.

In an embodiment, the controller is further configured to start a heating program when the detection result matches a preset startup parameter.

In an embodiment, the electronic vaporizer includes a plurality of first electrodes that are arranged at intervals and a plurality of second electrodes that are arranged at intervals, the plurality of first electrodes and the corresponding second electrodes are cooperatively configured to form equivalent capacitors at different positions on the aerosol-generation article, and the detection module detects dielectric constants at different positions on the aerosol-generation article by detecting capacitances of the equivalent capacitors at different positions.

A vaporization system is provided, including the foregoing aerosol-generation article and the foregoing electronic vaporizer adapted to the aerosol-generation article.

A method for identifying a type of an aerosol-generation article is provided, including the following steps:

detecting a dielectric constant of the aerosol-generation article, and determining that the aerosol-generation article is of an identifiable type when a detection result matches a preset value.

In an embodiment, the step of detecting a dielectric constant of the aerosol-generation article includes:

detecting a parameter associated with the dielectric constant, where the parameter is a capacitance value of an equivalent capacitor in which the aerosol-generation article is located or a resonance frequency of a resonance circuit in which the equivalent capacitor is located.

A device for identifying a type of an aerosol-generation article is provided, including a third electrode, a fourth electrode, a measuring module, and a main controller, where an accommodating region for accommodating the aerosol-generation article is formed between the third electrode and the fourth electrode, the measuring module is configured to detect a dielectric constant of the aerosol-generation article arranged in the accommodating region and feed back a detection result to the main controller, and the main controller is configured to compare the detection result with a preset value and determine that the aerosol-generation article is of a type identifiable by the device when the detection result matches the preset value.

A temperature control method for an electronic vaporizer is provided, including the following steps:

detecting a dielectric constant of an aerosol-generation article, and adjusting a temperature of the aerosol-generation article according to a detection result.

In an embodiment, the step of detecting a dielectric constant of an aerosol-generation article includes:

detecting a parameter associated with the dielectric constant, where the parameter is a capacitance value of an equivalent capacitor in which the aerosol-generation article is located or a resonance frequency of a resonance circuit in which the equivalent capacitor is located.

10: Vaporization system; 100: Aerosol-generation article; 110: Aerosol-generation substrate; 120: Temperature sensor; 200: Electronic vaporizer; 210: First electrode; 220: Second electrode; and 230: Electromagnetic shielding member.

For ease of understanding the present invention, the present invention is described more comprehensively below. The present invention may be implemented in many different forms, and is not limited to embodiments described in this specification. On the contrary, the embodiments are provided to make the disclosed content of the present invention clearer and more comprehensive.

It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. Orientation or position relationships indicated by terms such as “vertical”, “horizontal”, “left”, “right”, “upper”, “lower”, “inner”, “outer”, and “bottom” are based on orientation or position relationships shown in the accompanying drawings, and are used only for ease of description, rather than indicating or implying that the mentioned apparatus or element must have a particular orientation or must be constructed and operated in a particular orientation. Therefore, such terms should not be construed as a limitation to the present invention. In addition, terms “first” and “second” are merely used for description and should not be understood as indicating or implying relative importance.

Unless otherwise defined, meanings of all technical and scientific terms used in this specification are the same as that usually understood by a person skilled in the technical field to which the present invention belongs. In this specification, terms used in this specification of the present invention are merely intended to describe objectives of the specific embodiments, but are not intended to limit the present invention.

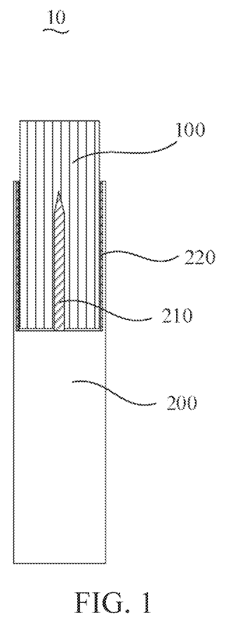

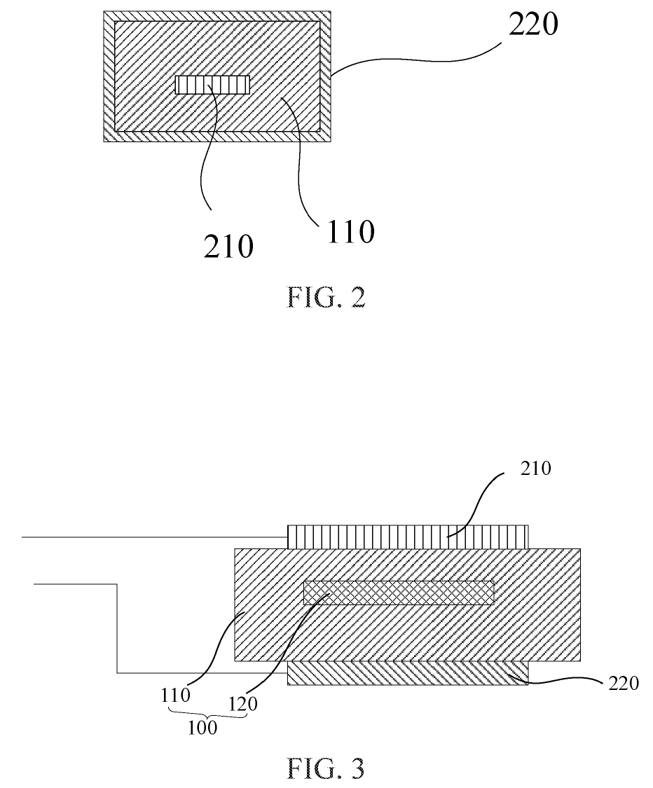

Referring to FIG. 1 and FIG. 2, an implementation of the present invention provides a vaporization system 10. The vaporization system 10 includes an aerosol-generation article 100 and an electronic vaporizer 200 adapted to the aerosol-generation article 100.

Specifically, the aerosol-generation article 100 can be heated and vaporized by the electronic vaporizer 200 to form aerosols. The aerosols are solid particles or suspended droplets in gas (for example, air).

The aerosol-generation article 100 includes a packaging layer, an aerosol-generation substrate 110, and a temperature sensor 120.

The packaging layer is used as outer packaging and is configured to wrap other components (for example, the aerosol-generation substrate 110 and the temperature sensor 120) of the aerosol-generation article 100 in the packaging layer. In some embodiments, the packaging layer is packaging paper or plastic. For example, when the aerosol-generation substrate 110 is a liquid substrate, the packaging layer is plastic, and the packaging layer can be directly used as a container for containing the aerosol-generation substrate 110 in this case. When the aerosol-generation substrate 110 is a solid substrate, the packaging layer is packaging paper. It may be understood that, when the aerosol-generation substrate 110 is a liquid substrate, a container for containing the aerosol-generation substrate 110 may alternatively be provided independently, and the packaging layer may alternatively be packaging paper in this case. In some embodiments, the packaging layer is in a shape of a cylinder, and the aerosol-generation article includes the aerosol-generation substrate 110, a hollow tubular element, and a suction nozzle member that are sequentially arranged on a central axis and defined by the packaging layer. The hollow tubular element is arranged between the aerosol-generation substrate 110 and the suction nozzle member and is configured to extend a distance that the aerosols reach the suction nozzle member, so as to buffer the aerosols. In some embodiments, a cooling element configured to cool the aerosols is further arranged in the hollow tubular element. In an embodiment, a filtering material (for example, acetate fiber) is further arranged in the suction nozzle member. In another embodiment, an aerosol cooling element is further arranged between the hollow tubular element and the suction nozzle member, to prevent the aerosols from being too hot. It may be understood that, in some embodiments, the aerosol-generation article 100 is the aerosol-generation substrate 110. That is, in this case, the aerosol-generation article 100 omits the packaging layer, the hollow tubular element, the suction nozzle member, and the cooling element. It may be understood that, in some implementations, some of the elements may alternatively be included.

The aerosol-generation substrate 110 is configured to form aerosols. In some embodiments, the aerosol-generation substrate 110 is a solid substrate. For example, the aerosol-generation substrate 110 is in at least one shape of powders, particles, sheets, wires, spaghettis, or strips. It may be understood that, the solid aerosol-generation substrate 110 is not limited to the foregoing shape and may also be in another shape.

Specifically, the aerosol-generation substrate 110 includes a functional material and a substrate material. The functional material causes the aerosol-generation substrate 110 to generate aerosols; and the substrate material provides support to the functional material to form the aerosol-generation substrate 110.

The functional material includes a volatile flavor substance and an aerosol-forming agent. The aerosol-forming agent is used for forming aerosols; and the volatile flavor substance is used for adding flavors to aerosols, and use amounts and types of the volatile flavor substance and the aerosols may be selected and matched according to a requirement. The volatile flavor substance is a natural raw material or artificially synthesized. Optionally, the volatile flavor substance is selected from at least one of alcohols, aldehydes, ketones, lipids, phenols, terpenoids, or low-grade fatty acids that include flavors. In an embodiment, the volatile flavor substance is an extract of at least one of a leaf, a stem, a root, or a flower of a plant. Certainly, the volatile flavor substance may be selected and matched according to an actual requirement. Certainly, in some embodiments, the volatile flavor substance may be omitted. In an embodiment, the aerosol-forming agent includes polyol. In a specific embodiment, the aerosol-forming agent is selected from at least one of triethylene glycol, butylene glycol, glycerol, or propylene glycol. It may be understood that, the aerosol-forming agent is not limited to the foregoing.

In some embodiments, the substrate material is made of a natural raw material including a volatile flavor substance; and the aerosol-generation substrate 110 is made by mixing the substrate material and the functional material. In an embodiment, the substrate material is at least one of a leaf, a stem, a root, or a flower of a plant. In an optional specific example, the plant is an herb. Under a heating condition, a natural material including a volatile flavor substance can release the flavor substance and form aerosols. It may be understood that, when the substrate material is made of a natural raw material (for example, an herb) including a volatile flavor substance, the volatile flavor substance and the aerosol-forming agent can be both provided by the substrate material, and the functional material can be omitted in this case. Optionally, the substrate material is tobacco.

In some other embodiments, the substrate material is an artificially synthesized material. In an embodiment, the substrate material is a porous material, and the functional material is filled in the substrate material. In another embodiment, the substrate material is in a shape of particles, wires, pieces, or powders, the functional material is distributed in the substrate material, and the aerosol-generation substrate 110 is formed by mixing the functional material and the substrate material. When the substrate material is an artificially synthesized material, the substrate material only serves as a carrier and does not release a flavor substance. Specifically, the substrate material is an artificially synthesized porous material, for example, a porous polymer.

It may be understood that, the aerosol-generation substrate 110 is not limited to a solid substrate and may also be a liquid substrate.

The temperature sensor 120 is configured to sense a temperature of the aerosol-generation substrate 110, which facilitates the electronic vaporizer 200 to control a heating temperature of the aerosol-generation substrate 110. The temperature sensor 120 includes a dielectric material whose dielectric constant changes with a temperature, and a Curie temperature of the dielectric material falls with a temperature range required by the aerosol-generation article 100 for forming aerosols. Because the dielectric constant of the dielectric material may change as the temperature changes, temperature measurement can be implemented by detecting changes of the dielectric constant of the dielectric material. The Curie temperature (Tc) is also referred to as a Curie point, which is a temperature at which the spontaneous magnetization strength in a magnetic material is reduced to zero, and is a critical point that a ferromagnetic or ferrimagnetic substance is converted into a paramagnetic substance. When the temperature is the Curie temperature, the dielectric constant of the dielectric material is maximized. By designing the Curie temperature of the dielectric material within the temperature range required by the aerosol-generation article 100 for forming aerosols, the sensitivity of the temperature sensor 120 can be improved.

In some embodiments, the dielectric material is a solid dielectric material. Optionally, the dielectric material is a ferroelectric material. In an embodiment, the dielectric material is selected from at least one of niobate, zirconate, titanate, or bismuthate. In an optional specific example, the dielectric material is selected from at least one of NaNbO₃, K_{0.5}Na₀.₅NbO₃, or 0.96K_{0.5}Na_{0.5}NbO₃-0.04Bi_{0.5}Na_{0.5}ZrO₃. It may be understood that, the dielectric material is not limited to the foregoing and may also be selected according to a specific situation. It may be understood that, in some other embodiments, the temperature sensor 120 may further include other components in addition to the dielectric material.

In some embodiments, the temperature range required by the aerosol-generation substrate 110 for forming aerosols ranges from 250° C. to 450° C.; and the Curie temperature of the dielectric material ranges from 250° C. to 450° C. Further, the temperature range required by the aerosol-generation substrate 110 for forming aerosols ranges from 250° C. to 400° C.; and the Curie temperature of the dielectric material ranges from 250° C. to 400° C. Further, the temperature range required by the aerosol-generation article 100 for forming aerosols ranges from 200° C. to 350° C.; and the Curie temperature of the dielectric material ranges from 200° C. to 350° C. In an embodiment, the temperature range required by the aerosol-generation substrate 110 for forming aerosols ranges from 250° C. to 400° C., and the Curie temperature of the dielectric material is 400° C.

In some embodiments, the temperature sensor 120 is arranged in the aerosol-generation substrate 110. In this case, the temperature sensor 120 represents a temperature inside the aerosol-generation substrate 110. In an embodiment, the temperature sensor 120 is in a shape of a rod or a sheet. In this case, the temperature sensor 120 is inserted in the aerosol-generation substrate 110. Further, a length direction of the temperature sensor 120 and a length direction of the aerosol-generation article 100 form an acute angle. In an optional specific example, the length direction of the temperature sensor 120 and the length direction of the aerosol-generation article 100 are the same. In another embodiment, the temperature sensor 120 is in a shape of particles, powders, or pieces. In this case, the temperature sensor 120 is distributed in the aerosol-generation substrate 110.

In some other embodiments, the temperature sensor 120 is arranged on a surface of the aerosol-generation substrate 110. Specifically, the aerosol-generation substrate 110 is a substrate including a shape (for example, a sheet or a column) formed by powders, particles, and/or wire-shaped fine materials through a forming process; and the temperature sensor 120 is arranged on an outer surface of the aerosol-generation substrate 110. In this case, the temperature sensor 120 represents a temperature outside the aerosol-generation substrate 110.

In some other embodiments, the temperature sensor 120 is arranged on a surface of the packaging layer and close to the aerosol-generation substrate 110. In this case, the temperature sensor 120 represents a temperature outside the aerosol-generation substrate 110. In an embodiment, the temperature sensor 120 is arranged on an outer surface of the packaging layer. In another embodiment, the temperature sensor 120 is arranged on an inner surface of the packaging layer.

The electronic vaporizer 200 is configured to heat the aerosol-generation substrate 110, to vaporize the aerosol-generation substrate 110 to generate aerosols. Specifically, the electronic vaporizer 200 includes a housing, a power source, a heating module, a first electrode 210, a second electrode 220, a detection module, and a controller. The housing is configured to accommodate other elements of the electronic vaporizer 200. The power source supplies power to other components (for example, a heating body and the controller) in the electronic vaporizer 200. A cavity adapted to the aerosol-generation article 100 according to any one of the foregoing embodiments is formed between the first electrode 210 and the second electrode 220; and the first electrode 210, the second electrode 220, and the aerosol-generation article 100 arranged between the first electrode 210 and the second electrode 220 form an equivalent capacitor. The detection module is configured to detect a dielectric constant of the aerosol-generation article 100 accommodated in the cavity and feed back a detection result to the controller. The controller is configured to control power supply to the heating module according to the detection result to control a temperature of the aerosol-generation substrate 110, thereby preventing the aerosol-generation article 100 from generating a burnt flavor due to an excessively high temperature of the aerosol-generation substrate 110. It may be understood that, the detection module may directly detect a dielectric constant of a part of the aerosol-generation article 100 that is arranged between the first electrode 210 and the second electrode 220, or may indirectly obtain the dielectric constant of the part of the aerosol-generation article 100 that is arranged between the first electrode 210 and the second electrode 220 by detecting a parameter related to the dielectric constant. For example, changes of the dielectric constant of the aerosol-generation article 100 is detected by detecting capacitance changes of the equivalent capacitor formed by the first electrode 210, the second electrode 220, and the aerosol-generation article 100 arranged between the first electrode 210 and the second electrode 220 or a resonance frequency of a resonance circuit in which the equivalent capacitor is located. Specifically:

The housing includes an accommodating cavity, and the power source, the heating module, the first electrode, the second electrode, the controller, and the detection module are all arranged in the accommodating cavity. Specifically, the accommodating cavity includes a bottom portion and an opening opposite to the bottom portion.

In an embodiment, the power source is close to the bottom portion of the accommodating cavity. It may be understood that, in some embodiments, the power source may be omitted, and in this case, the electronic vaporizer 200 needs to be connected to an external power source for use.

The heating module serves as a heating component of the electronic vaporizer 200 and is configured to heat the aerosol-generation article 100. The heating module includes a heating body. In some embodiments, the heating body is closer to the opening of the accommodating cavity than the power source, and the heating body is electrically connected to the power source to form a heating circuit. The aerosol-generation substrate is directly heated by heating of the heating body to form aerosols. It may be understood that, a heating manner of the heating body is not limited, which may be resistive heating (heat is generated after a heating resistor is energized) or may be electromagnetic heating (heat is generated through electromagnetic induction, and the heating body is not electrically connected to the power source in this case). Certainly, a shape of the heating body is not specifically limited. In an embodiment, the heating body is a heating sheet or a heating rod. In this case, the aerosol-generation substrate 110 is sleeved on the heating body and heated from inside to outside. In another embodiment, the heating body is a heating sleeve or a heating barrel. In this case, the aerosol-generation substrate 110 is arranged in the heating body to be heated from outside to inside. It may be understood that, in some embodiments, the heating body may also be a component of the aerosol-generation article 100. For example, when heating is performed through electromagnetic induction, a magnetic induction member is distributed in the aerosol-generation substrate 110, and the magnetic induction member distributed in the aerosol-generation substrate generates heat to heat the aerosol-generation substrate 110. Certainly, the heating body may also be arranged on the aerosol-generation article 100 and the electronic vaporizer 200.

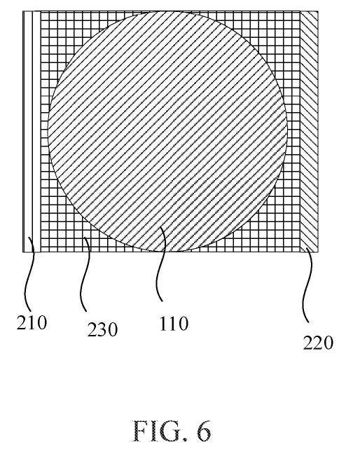

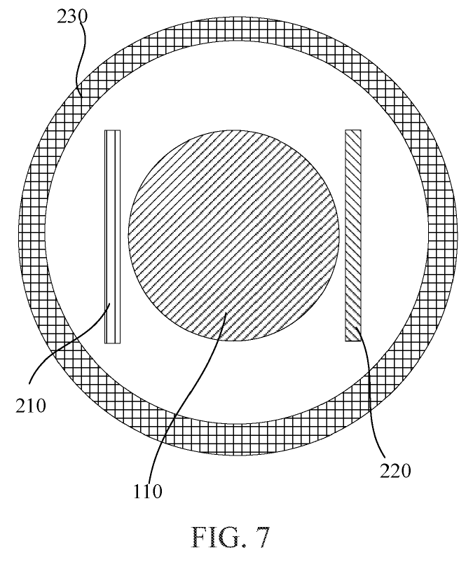

Referring to FIG. 5 to FIG. 8, in some embodiments, the first electrode 210 is in a shape of a plate or a cylinder; and the second electrode 220 is in a shape of a plate or a cylinder. In the embodiment shown in FIG. 2, the first electrode 210 is in a shape of a plate, the second electrode 220 is in a shape of a cylinder, and the first electrode 210 is arranged in the second electrode 220. In the embodiment shown in FIG. 5, the first electrode 210 is in a shape of a column, the second electrode 220 is in a shape of a cylinder, and the first electrode 210 and the second electrode 220 are concentrically arranged. In the embodiments shown in FIG. 6 and FIG. 7, the first electrode 210 and the second electrode 220 are both in a shape of a plate.

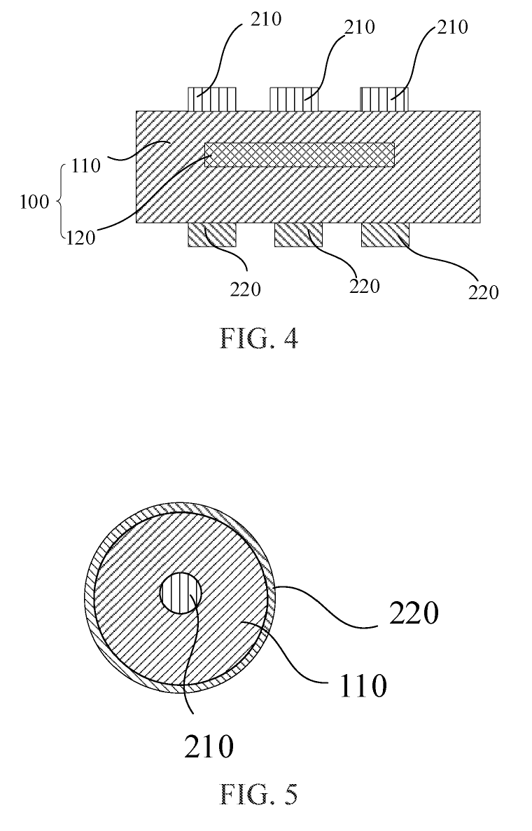

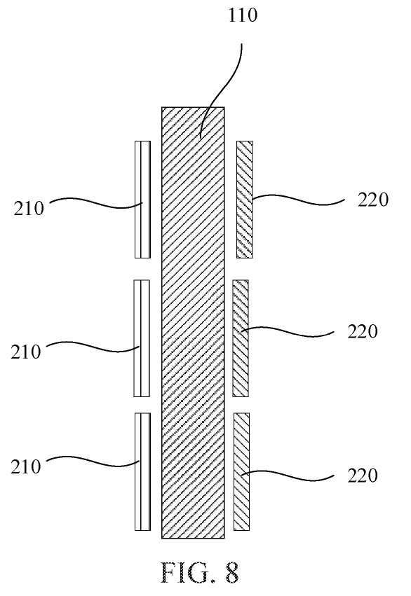

In some embodiments, the numbers of the first electrodes 210 and the second electrodes 220 are both one, for example, the embodiments shown in FIG. 2, FIG. 3, and FIG. 5 to FIG. 7. In some other embodiments, the electronic vaporizer includes a plurality of first electrodes 210 that are arranged at intervals and a plurality of second electrodes 220 that are arranged at intervals, and the plurality of first electrodes 210 and the corresponding second electrodes 220 are cooperatively configured to form equivalent capacitors at different positions on the aerosol-generation article 100, for example, the embodiments shown in FIG. 4 and FIG. 8. The power source supplies power to the heating module according to a preset mode. Optionally, the preset mode is to perform segmented heating with different powers or perform sequential segmented heating. Specifically, the segmented heating with different powers refers to that heating degrees of different positions on the aerosol-generation substrate 110 are different. For example, in an embodiment whose structure arrangement is shown in FIG. 8, the aerosol-generation substrate 110 is divided into an upper segment, a middle segment, and a lower segment from top to bottom according to positions corresponding to the first electrode 210 and the second electrode 220. The middle segment of the aerosol-generation substrate 110 has a largest heating degree and a highest temperature, and the upper segment and the lower segment have smaller heating degrees and lower temperatures than the middle segment. The sequential segmented heating refers to that the heating degree of the aerosol-generation substrate is gradually increased or decreased in a specific direction. For example, in another embodiment whose structure arrangement is shown in FIG. 8, the aerosol-generation substrate 110 is divided into an upper segment, a middle segment, and a lower segment from top to bottom according to positions corresponding to the first electrode 210 and the second electrode 220. The heating degree and the temperature of the aerosol-generation substrate 110 are sequentially increased according to a sequence of the lower segment, the middle segment, and the upper segment.

In the embodiment shown in FIG. 8, the numbers of the first electrodes 210 and the second electrodes 220 are both three. It may be understood that, in some other embodiments, the number of the first electrodes 210 is not limited to three and may also be any other integer greater than one; and the number of the second electrodes 220 is also not limited to three and may also be any other integer greater than one.

In some embodiments, the detection module is configured to detect capacitance changes of the equivalent capacitor formed by the first electrode 210, the second electrode 220, and the aerosol-generation article 100 arranged between the first electrode 210 and the second electrode 220. Changes of the dielectric constant of the aerosol-generation article 100 are detected by detecting the capacitance changes of the equivalent capacitor. Specifically, the detection module is configured to detect a capacitance of the equivalent capacitor and feed back a detection result to the controller; and the controller matches the detection result fed back by the detection module with a preset heating program to implement heating control. In this case, the principle that the controller obtains the temperature of the aerosol-generation substrate 110 is that: there is a correspondence between the dielectric constant of the dielectric material of the temperature sensor 120 and the temperature, and there is a correspondence between the capacitance of the equivalent capacitor and the dielectric constant of the dielectric material of the temperature sensor 120 in the equivalent capacitor. Therefore, the temperature of the aerosol-generation substrate 110 that is sensed by the temperature sensor 120 can be obtained by detecting the capacitance of the equivalent capacitor. Specifically, the controller stores a dielectric constant-temperature feature curve of the dielectric material of the temperature sensor 120. It may be understood that, when the dielectric constant-temperature feature curve of the dielectric material of the temperature sensor 120 is stored in the controller, changes of dielectric constants of other components with the temperature of the aerosol-generation article 100 between the first electrode 210 and the second electrode 220 can be omitted. It may be understood that, in some other embodiments, the feature curve stored in the controller is not limited to the dielectric constant-temperature feature curve of the dielectric material of the temperature sensor 120, and may also be a dielectric constant-temperature feature curve of a composite material formed by the dielectric material and other related materials, provided that the temperature of the aerosol-generation substrate 110 can be reflected. Certainly, in this case, the changes of the dielectric constants of other components with the temperature other than the dielectric material of the temperature sensor 120 of the aerosol-generation article 100 are not specifically limited.

In an embodiment that a plurality of equivalent capacitors are formed, the detection module detects capacitances of equivalent capacitors at different positions to detect dielectric constants at different positions on the aerosol-generation article 100, and the controller can further comprehensively adjust the temperature of the aerosol-generation substrate 110. It may be understood that, the detection module may detect the capacitances of the equivalent capacitors at different positions at the same time, or may detect the capacitances of the equivalent capacitors at different positions sequentially within a specific time range.

In some embodiments, the detection module is configured to detect changes of a resonance frequency of a resonance circuit in which the equivalent capacitor is located. The changes of the dielectric constant of the aerosol-generation article 100 is obtained by detecting the changes of the resonance frequency of the resonance circuit in which the equivalent capacitor is located. Specifically, the electronic vaporizer 200 further includes an inductance coil. The power source, the inductance coil, and the equivalent capacitor form a resonance circuit; the detection module is configured to detect a resonance frequency of the resonance circuit and feed back a detection result to the controller; and the controller matches the detection result fed back by the detection module with a preset heating program to implement heating control. In this case, the principle that the controller obtains the temperature of the aerosol-generation substrate 110 is that: there is a correspondence between the dielectric constant of the dielectric material of the temperature sensor 120 and the temperature, there is a correspondence between the capacitance of the equivalent capacitor and the dielectric constant of the dielectric material of the temperature sensor 120 in the equivalent capacitor, and there is a correspondence between the resonance frequency of the resonance circuit and the capacitance of the equivalent capacitor. Therefore, the temperature of the aerosol-generation substrate 110 that is sensed by the temperature sensor 120 can be obtained by detecting the resonance frequency of the resonance circuit.

Further, because the temperature change in the aerosol-generation substrate is apparent when aerosols formed by the aerosol-generation article 100 are inhaled, the change can be sensed by the temperature sensor 120, and the change can be reflected on the resonance frequency (the resonance frequency jumps apparently), the number of times of inhalation can be counted according to peaks and valleys of the feature change of the resonance frequency, and an output of an alternating voltage generator is adjusted according to the counted number of times of inhalation to improve the taste of the aerosols. Therefore, in some embodiments, the electronic vaporizer 200 further includes an inhalation counting module. The inhalation counting module is configured to collect the number of peaks and/or valleys of the resonance frequency, calculate the number of times of inhalation, and feed back the number of times of inhalation to the controller. In this case, the controller is further configured to control the output of the alternating voltage generator according to a counting result fed back by the counting module.

Specifically, the heating program includes a warming program and a cooling program. When a temperature corresponding to the detection result (the capacitance of the equivalent capacitor, the dielectric constant, or the resonance frequency) fed back by the detection module and received by the controller is lower than a preset cooling temperature, the controller controls the power source to supply normal power to the heating module, which is the warming program; and when the temperature corresponding to the detection result fed back by the detection module and received by the controller is higher than or equal to the preset cooling temperature, the controller controls the power source to reduce power supply to the heating module, which is the cooling program.

In some embodiments, the controller is further configured to control a heating start program. Specifically, when the aerosol-generation article 100 is arranged between the first electrode 210 and the second electrode 220 to form an equivalent capacitor, the detection module detects the dielectric constant of the aerosol-generation article 100 arranged between the first electrode 210 and the second electrode 220 and feeds back a detection result to the controller, and the controller matches the detection result fed back by the detection module with a preset startup parameter. If the detection result matches the preset startup parameter, the heating program is started; and if the detection result does not match the preset startup parameter, the heating program is not started. The heating start program is controlled by the controller, so that the heating program is started only after the aerosol-generation article 100 is identified by the electronic vaporizer 200 as a heatable aerosol-generation article, thereby preventing false heating and improving the user experience. Meanwhile, the electronic vaporizer 200 corresponds to the heatable aerosol-generation article 100, which also achieves an anti-counterfeiting effect. It may be understood that, the preset startup parameter is a range in consideration of application scenarios of the aerosol-generation article 100. It may be understood that, similarly, when the controller is further configured to control the heating start program, a parameter detected by the detection module is also not limited to the dielectric constant of the aerosol-generation article 100 arranged between the first electrode 210 and the second electrode 220, and may also be another parameter related to the dielectric constant, such as the capacitance of the equivalent capacitor or the resonance frequency of the resonance circuit in which the equivalent capacitor is located that can indirectly reflect the dielectric constant.

In the foregoing embodiment, identification is implemented by using the detection module of the electronic vaporizer 200 to detect the capacitance or the resonance frequency corresponding to the dielectric constant of the aerosol-generation article arranged between the first electrode 210 and the second electrode 220. It may be understood that, in some other embodiments, that the electronic vaporizer 200 identifies the aerosol-generation article 100 may also be implemented through an identifying material (for example, an identifying label) additionally arranged on the aerosol-generation article 100 and a corresponding identifying module arranged on the electronic vaporizer 200. For example, the aerosol-generation article 100 further includes an identifying material adapted to the electronic vaporizer 200. In some embodiments, the identifying material is arranged in the aerosol-generation substrate 110 or arranged on a surface of the aerosol-generation substrate 110. In some other embodiments, the identifying material is arranged on the packaging layer. For example, the identifying material is arranged on an outer surface or an inner surface of the packaging layer. It may be understood that, specific compositions of the identifying material are not specifically limited, provided that the identifying material can be adapted to the identifying module of the electronic vaporizer 200. Certainly, in some embodiments, if the electronic vaporizer 200 does not need to have an identifying function, the electronic vaporizer 200 also does not need to have a corresponding identifying module, and the aerosol-generation article 100 also does not need to be provided with an identifying material.

In some embodiments, the electronic vaporizer 200 may alternatively not include the heating module. For example, the electronic vaporizer 200 provides an alternating electric field, and the aerosol-generation substrate 110 of the aerosol-generation article 100 is a material that can generate heat under the action of the alternating electric field, or the aerosol-generation article 100 further includes a heating auxiliary material that can generate heat under the action of the alternating electric field.

Optionally, the aerosol-generation substrate 110 can generate heat under the action of the alternating electric field to form aerosols through vaporization. The aerosol-generation substrate 110 has complex compositions, and at the molecule level, a sequence of molecules included in the aerosol-generation substrate 110 in a natural state is disordered; because a dipole moment of each polar molecule is not zero, polar molecules in the aerosol-generation substrate 110 suffer an electric field force under the action of the electric field and rotate; and under the action of the alternating electric field at a specific frequency, the polar molecules rotate or vibrate, and friction or collision occurs among the molecules to generate heat. Therefore, alternating electric field heating is to place a medium in an alternating electric field at a specific frequency, polar molecules in the medium rotate or vibrate at a high speed under the action of the alternating electric field, so that friction or collision occurs, and the medium generates heat. The frequency of the alternating electric field causing the medium to generate heat is related to properties of the medium, so that the alternating electric field heating may be performed selectively. Under the action of the alternating electric field, the aerosol-generation substrate 110 generates heat at a high speed and uniformly, so that the utilization of the aerosol-generation substrate 110 is high. In addition, because the aerosol-generation substrate 110 can generate heat to vaporize the aerosol-generation substrate to form aerosols, the matching electronic vaporizer 200 does not need to be provided with a heating body, thereby preventing the inhalation taste from being affected by dirt deposited on the heating body, and use of the electronic vaporizer 200 is more convenient.

Specifically, the aerosol-generation substrate 110 includes polar molecules. The polar molecules generate heat under the action of the alternating electric field, to implement heating. In some embodiments, the polar molecules are at least one of water, alcohols, aldehydes, ketones, lipids, phenols, terpenoids, or low-grade fatty acids. Water is a polar molecule having a good polarity, and when the content of water in the aerosol-generation substrate 110 is relatively great, water may be used as a heating substance to cause the aerosol-generation substrate 110 to form aerosols through vaporization. In an embodiment, water content in the aerosol-generation substrate 110 ranges from 6 wt% to 18 wt%. Further, the water content in the aerosol-generation substrate 110 ranges from 8 wt% to 14 wt%. Alcohols, aldehydes, ketones, lipids, phenols, terpenoids, and low-grade fatty acids have polarities and may be heated by an alternating electric field at an appropriate frequency. In some embodiments, at least one of alcohols, aldehydes, ketones, lipids, phenols, terpenoids, and low-grade fatty acids is mainly used as a flavor substance, but content of the alcohols, aldehydes, ketones, lipids, phenols, terpenoids, or low-grade fatty acids used as the flavor substance is generally relatively small, which cannot be independently used for heat generation or cannot achieve an apparent heating effect, and need to match other polar molecules (for example, water) to generate heat. It may be understood that, in some embodiments, at least one of alcohols, aldehydes, ketones, lipids, phenols, terpenoids, or low-grade fatty acids may also be used as a heating substance, and content thereof in this case is enough to cause the aerosol-generation substrate 110 to form aerosols through vaporization.

Optionally, the aerosol-forming agent includes water and/or other polar molecules. In an embodiment, the aerosol-generation substrate 110 is a solid substrate, and water content in the aerosol-generation substrate 110 ranges from 6 wt% to 18 wt%. Further, the water content in the aerosol-generation substrate 110 ranges from 8 wt% to 14 wt%. In an optional specific example, the substrate material is tobacco. Main compositions in the tobacco are insoluble polysaccharides, such as starch, cellulose, and pectin. Content of the starch in mature tobacco ranges from 10% to 30%; the cellulose is a basic substance forming cellular tissue and skeleton of the tobacco, and content of the cellulose in the tobacco is generally about 11%, which increases as a grade of the tobacco decreases; and content of the pectin in the tobacco is about 12%, the pectin affects physical performance such as the elasticity and toughness of the tobacco, due to the existence of the pectin, when water content in the tobacco is great, the elasticity and toughness of the tobacco are increased, and when water content is small, the tobacco is friable and fragile. Certainly, when the substrate material is tobacco, the functional material can be omitted. In this case, the water content of the tobacco is enough to cause the tobacco to be heated under the action of the alternating electric field to form aerosols through vaporization. For example, in this case, the water content of the tobacco ranges from 6 wt% to 18 wt%.

Optionally, the aerosol-generation article 100 further includes a heating auxiliary material that can generate heat under the action of the alternating electric field. The heating auxiliary material is close to the aerosol-generation substrate 110, and the heating auxiliary material heats the aerosol-generation substrate 110 to cause the aerosol-generation substrate to form aerosols through vaporization. Specifically, the heating auxiliary material is arranged in the aerosol-generation substrate 110. Further, the heating auxiliary material is distributed in the aerosol-generation substrate 110. By distributing the heating auxiliary material in the aerosol-generation substrate 110, the aerosol-generation substrate 110 can be heated uniformly, and the consistency of aerosols formed by the aerosol-generation substrate 110 is better. It may be understood that, in some embodiments, the heating auxiliary material is not limited to being distributed in the aerosol-generation substrate, and may also be in a shape of a sheet, a rod, or a pin and close to the aerosol-generation substrate 110, to conduct heat to the aerosol-generation substrate 110.

In some embodiments, the heating auxiliary material is a material that can generate heat more easily and/or have a higher heating efficiency than the aerosol-generation substrate 110 in the alternating electric field in which the aerosol-generation substrate 110 is located. In this case, one part of a heat source for vaporization of the aerosol-generation substrate 110 is heat generated by the aerosol-generation substrate under the alternating electric field, and another part of the heat source is heat generated by the heating auxiliary material under the alternating electric field. It may be understood that, in some embodiments, heat generated by the aerosol-generation substrate 110 under the action of the alternating electric field is relatively small. In this case, heat required for vaporization of the aerosol-generation substrate 110 is mainly from heat generated by the heating auxiliary material.

Optionally, under the action of the alternating electric field, a dielectric loss factor of the heating auxiliary material is greater than a dielectric loss factor of the aerosol-generation substrate 110. It may be understood that, the heating auxiliary material can have a higher heating efficiency than the aerosol-generation substrate 110 under a heating frequency of the alternating electric field, which can achieve a more efficient heating efficiency. For example, a dielectric loss of tobacco with water content of 15 wt% is about 0.075, the dielectric loss increases as the water content increases, and the dielectric loss is about 0.487 when the water content is 30 wt%. However, the quality of the tobacco may be affected when the water content is excessively great. Therefore, it is relatively appropriate when the water content of the aerosol-generation substrate 110 ranges from 6 wt% to 18 wt%. Meanwhile, in a case that the water content is relatively low, to improve the heating efficiency, the heating auxiliary material may be added to the aerosol-generation substrate 110 to improve the heating efficiency.

In some embodiments, the heating auxiliary material is attenuation ceramic. In an optional specific example, the attenuation ceramic is aluminum nitride-based attenuation ceramic. The aluminum nitride-based attenuation ceramic has good thermal conduction performance, where a theoretical value of thermal conductivity is about 320 W/m·K, and has a moderate thermal expansion coefficient, reliable electrical insulation, stable chemical and thermal performance, good mechanical performance, and no toxicity. In addition, during actual production, some substances with a great loss, for example, attenuation agents such as SiC, TiB₂, Mo, W, and C, are generally added to a substrate of the aluminum nitride-based attenuation ceramic, to achieve a specific attenuation effect. In some specific embodiments, a dielectric loss of AlN-TiB₂ attenuation ceramic is about 0.17, and a dielectric loss of tobacco whose water content is greater than 15% is 0.075.

Certainly, when the electronic vaporizer 200 does not include the heating module, the electronic vaporizer 200 further includes an alternating voltage generator. The alternating voltage generator is electrically connected to the power source, and the alternating voltage generator provides an alternating voltage for the first electrode 210 and the second electrode 220, to form an alternating electric field between the first electrode 210 and the second electrode 220. An accommodating space that can accommodate the aerosol-generation substrate 110 is provided in at least some regions on which the alternating electric field is distributed, so that the aerosol-generation substrate 110 in the alternating electric field can generate heat and form aerosols through vaporization under the action of the alternating electric field. The alternating voltage generator, the first electrode 210, and the second electrode 220 are used as components of an alternating electric field generation module. Certainly, in this case, the first electrode 210, the aerosol-generation article 100 arranged between the first electrode 210 and the second electrode 220, and the second electrode 220 also form an equivalent capacitor.

A frequency of an alternating electric field generated by the alternating electric field generation module is adapted to the heated aerosol-generation substrate 110 and/or heating auxiliary material. Optionally, the frequency of the alternating electric field generated by the alternating electric field generation module ranges from 10 MHz to 5 GHz. In an embodiment, the frequency of the alternating electric field generated by the alternating electric field generation module ranges from 10 MHz to 49 MHz. In an optional specific example, a frequency of an alternating electric field required by the aerosol-forming substrate for generating aerosols is 10 MHz, 15 MHz, 20 MHz, 25 MHz, 30 MHz, 35 MHz, 40 MHz, or 49 MHz. In some other embodiments, the frequency of the alternating electric field generated by the alternating electric field generation module ranges from 981 MHz to 5 GHz. In an optional specific example, a frequency of an alternating electric field required by the aerosol-forming substrate for generating aerosols is 985 MHz, 1000 MHz, 1 GHz, 1.5 GHz, 2 GHz, 2.5 GHz, 3 GHz, 3.5 GHz, 4 GHz, or 4.5 GHz. Further, the frequency of the alternating electric field generated by the alternating electric field generation module ranges from 985 MHz to 1000 MHz, from 1 GHz to 1.5 GHz, from 1.6 GHz to 2 GHz, from 2.1 GHz to 2.5 GHz, from 2.6 GHz to 3 GHz, from 3.1 GHz to 3.5 GHz, or from 3.6 GHz to 4 GHz.

In an embodiment, a waveform of an alternating voltage generated by the alternating voltage generator is a sine wave, a square wave, or a sawtooth wave.

In some embodiments, the electronic vaporizer 200 further includes an electromagnetic shielding member 230, and the electromagnetic shielding member 230 is configured to shield or attenuate an overflowed electromagnetic field excited by the alternating electric field between the first electrode 210 and the second electrode 220. In an embodiment, a material of the electromagnetic shielding member 230 is selected from a conductive material, a composite material of metals and insulators, or a ferrite material. In an optional specific example, the conductive material is selected from at least one of copper, aluminum, iron, or nickel. The composite material is selected from rubber or plastic filled with metal powder or metal fiber (for example, nickel wire, copper wire, or silver wire). The ferrite material is selected from manganese-zinc ferrite or nickel-copper ferrite. It may be understood that, in some other embodiments, the conductive material, the composite material of metals and insulators, and the ferrite material forming the electromagnetic shielding member 230 are not limited to the foregoing.

In some embodiments, the electromagnetic shielding member 230 is arranged between the first electrode 210 and the second electrode 220, and wraps the aerosol-generation article 100 in the electromagnetic shielding member, for example, the embodiment shown in FIG. 6. In some other embodiments, the electromagnetic shielding member 230 is arranged outside the equivalent capacitor formed by the first electrode 210, the aerosol-generation substrate 110, and the second electrode 220, and wraps the equivalent capacitor in the electromagnetic shielding member, for example, the embodiment shown in FIG. 7.

Certainly, when the electronic vaporizer 200 does not include the heating module, the controller may control power supply of the power source to the alternating voltage generator or control an output of the alternating voltage generator, to control the temperature of the aerosol-generation substrate 110.

Because the dielectric constant of the dielectric material changes as the temperature changes, the capacitance of the equivalent capacitor changes as the dielectric constant of the dielectric material between plates of the capacitor changes. In the foregoing vaporization system 10, the dielectric material of the temperature sensor 120 of the aerosol-generation article 100 is set to be a solid material, and the temperature sensor 120 of the aerosol-generation article 100 forms an equivalent capacitor with the first electrode 210 and the second electrode 220, so that the detection module detects a capacitance of the equivalent capacitor to implement temperature measurement of the temperature sensor 120; and the controller controls the power supply of the power source to the heating module according to a temperature situation fed back by the temperature sensor 120 to implement temperature control. The vaporization system 10 at least includes the following advantages:

(1) Beneficial to structure optimization and cleaning of the electronic vaporizer 200. The temperature sensor 120 and the electronic vaporizer 200 are separated, the temperature sensor 120 is not dependent on the electronic vaporizer 200, so that the electronic vaporizer 200 has more possible structures, which is beneficial to structure optimization of the electronic vaporizer 200. In addition, because the temperature sensor 120 is not designed on the electronic vaporizer 200 (close to the heating body), a surface of the electronic vaporizer 200 that is in contact with the aerosol-generation article 100 may not have the temperature sensor 120 and is easier to clean.

(2) High sensitivity of the temperature sensor 120. The Curie temperature of the dielectric material of the temperature sensor 120 of the aerosol-generation article 100 in the vaporization system 10 is set within the temperature range required by the aerosol-generation article 100 for forming aerosols, so that the great changes of the dielectric constant of the dielectric material with the temperature can be reflected on the capacitance more easily, which is more beneficial to detection. Therefore, the sensitivity of the temperature sensor 120 is higher, and the temperature control accuracy of the electronic vaporizer 200 is higher.

In addition, because temperature control can be implemented by detecting the changes of the dielectric constant of the aerosol-generation article 100 with the changes of the temperature, an implementation of the present invention further provides a device for identifying a type of the aerosol-generation article 100, a method for identifying a type of the aerosol-generation article 100, and a temperature control method for the electronic vaporizer 200. Specifically:

According to an implementation, a device for identifying a type of an aerosol-generation article 100 is provided, including a third electrode, a fourth electrode, a measuring module, and a main controller, where an accommodating region for accommodating the aerosol-generation article 100 is formed between the third electrode and the fourth electrode, the measuring module is configured to detect a dielectric constant of the aerosol-generation article 100 arranged in the accommodating region and feed back a detection result to the main controller, and the main controller is configured to compare the detection result with a preset value and determine that the aerosol-generation article 100 is of a type identifiable by the device when the detection result matches the preset value; and the main controller determines that the aerosol-generation article 100 is of a type that cannot be identified by the device when the detection result does not match the preset value.

It may be understood that, the preset value is a value or a value range corresponding to the detection result. For example, in some embodiments, the measuring module directly detects the dielectric constant of the aerosol-generation article 100, and the detection result fed back by the measuring module to the main controller is the dielectric constant of the aerosol-generation article 100. In this case, the preset value is a preset value or value range corresponding to the dielectric constant. In some other embodiments, the measuring module indirectly reflects the dielectric constant of the aerosol-generation article 100 by detecting a capacitance value of an equivalent capacitor 100 in which the aerosol-generation article is located, and the detection result is the capacitance value of the equivalent capacitor. In this case, the preset value is a preset value or value range corresponding to the capacitance value. In another embodiment, the measuring module indirectly reflects the dielectric constant of the aerosol-generation article 100 by detecting a resonance frequency of a resonance circuit in which the aerosol-generation article 100 is located, and the detection result is the resonance frequency. In this case, the preset value is a preset value or value range corresponding to the resonance frequency. Certainly, when the measuring module indirectly detects the dielectric constant of the aerosol-generation article 100, the preset value may also be set as a preset value or value range corresponding to the dielectric constant. In this case, the detection result that is obtained by the measuring module and indirectly reflects the dielectric constant of the aerosol-generation article 100 needs to be converted into the dielectric constant.

Certainly, the device includes a determination result output module. The determination result output module is configured to present a determination result of the main controller for a user. For example, the output module includes a unit outputting a prompt voice and/or prompt text.

The device identifies the type of the aerosol-generation article 100 through the dielectric constant of the aerosol-generation article 100, which may be applied to sorting of the aerosol-generation article 100 during production and packaging.

According to an implementation, a method for identifying a type of an aerosol-generation article 100 is provided, including the following steps:

detecting a dielectric constant of the aerosol-generation article 100, and determining that the aerosol-generation article 100 is of an identifiable type when a detection result matches a preset value.

In some embodiments, the aerosol-generation article 100 is detected, to directly obtain the dielectric constant of the aerosol-generation article 100. In some other embodiments, a parameter associated with the dielectric constant of the aerosol-generation article 100 is detected, to indirectly obtain the dielectric constant of the aerosol-generation article 100. For example, a capacitance value of an equivalent capacitor in which the aerosol-generation article 100 is located or a resonance frequency of a resonance circuit in which the equivalent capacitor is located is detected, to indirectly obtain the dielectric constant of the aerosol-generation article 100. Certainly, the preset value is a value or value range corresponding to the detection result.

In some embodiments, the aerosol-generation article 100 is placed in the device according to any one of the foregoing embodiments, to identify the type of the aerosol-generation article 100. Specifically, after the aerosol-generation article 100 is placed in the accommodating region, the measuring module detects the dielectric constant of the aerosol-generation article 100 placed in the accommodating region and feeds back a detection result to the main controller; the main controller compares the detection result with a preset value, and determines that the aerosol-generation article 100 is of a type identifiable by the device when the detection result matches the preset value; and the main controller determines that the aerosol-generation article 100 is of a type that cannot be identifiable by the device when the detection result does not match the preset value.

According to an implementation, a temperature control method for an electronic vaporizer 200 is provided, including the following steps: detecting a dielectric constant of an aerosol-generation article 100, and adjusting a temperature of the aerosol-generation article 100 according to a detection result.

In some embodiments, the aerosol-generation article 100 is detected, to directly obtain the dielectric constant of the aerosol-generation article 100. In some other embodiments, a parameter associated with the dielectric constant of the aerosol-generation article 100 is detected, to indirectly obtain the dielectric constant of the aerosol-generation article 100. For example, a capacitance value of an equivalent capacitor in which the aerosol-generation article 100 is located or a resonance frequency of a resonance circuit in which the equivalent capacitor is located is detected, to indirectly obtain the dielectric constant of the aerosol-generation article 100.

In some embodiments, power supply is adjusted to adjust a temperature of the aerosol-generation article 100. In some other embodiments, an alternating electric field is adjusted to adjust the temperature of the aerosol-generation article 100.

In some embodiments, the electronic vaporizer 200 is the electronic vaporizer 200 according to any one of the foregoing embodiments, and the temperature control method includes the following steps:

After the aerosol-generation article 100 is placed in the cavity formed between the first electrode 210 and the second electrode 220, the detection module detects the dielectric constant of the aerosol-generation article 100 and feeds back a detection result to the controller, the controller controls power supply of the power source to the heating module according to the detection result, and when a temperature corresponding to the detection result is lower than a preset cooling temperature, the controller controls the power source to supply normal power to the heating module; and when the temperature corresponding to the detection result is higher than or equal to the preset cooling temperature, the controller controls the power source to reduce power supply to the heating module.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An aerosol-generation article, comprising:
an aerosol-generation substrate; and
a temperature sensor comprising a dielectric material whose dielectric constant changes with a temperature,
wherein a Curie temperature of the dielectric material falls with a temperature range required by the aerosol-generation substrate for forming aerosols.

2. The aerosol-generation article of claim 1, wherein the Curie temperature of the dielectric material ranges from 200° C. to 450° C.

3. The aerosol-generation article of claim 2, wherein the dielectric material comprises at least one of niobate, zirconate, titanate, or bismuthate.

4. The aerosol-generation article of claim 3, wherein the dielectric material comprises at least one of NaNbO3, K0.5Na0.5NbO3, or 0.96K0.5Na0.5NbO3-0.04Bi0.5Na0.5ZrO3.

5. The aerosol-generation article of claim 1, wherein the temperature sensor comprises a sheet, a pin, or a particle.

6. The aerosol-generation article of claim 1, further comprising:
a packaging layer,
wherein the aerosol-generation substrate is arranged in the packaging layer and is wrapped by the packaging layer, and
wherein the temperature sensor is arranged on an outer side of the packaging layer or the temperature sensor is arranged in the aerosol-generation substrate.

7. An electronic vaporizer, comprising:
a first electrode, a second electrode, a detection module, a controller, and a heating module,
wherein a cavity configured to accommodate an aerosol-generation article is formed between the first electrode and the second electrode,
wherein the detection module is configured to detect a dielectric constant of the aerosol-generation article accommodated in the cavity and feed back a detection result to the controller, and
wherein the controller is configured to control power supply to the heating module of the detection result.

8. The electronic vaporizer of claim 7, wherein the first electrode, the aerosol-generation article accommodated in the cavity, and the second electrode comprise an equivalent capacitor, and
wherein the electronic vaporizer further comprises an inductance coil,
wherein the inductance coil, the equivalent capacitor, and a power source comprise a resonance circuit,
wherein the detection module is configured to detect a resonance frequency of the resonance circuit, and
wherein the controller is configured to control power supply of the power source to the heating module of the resonance frequency.

9. The electronic vaporizer of claim 7, wherein, when a temperature corresponding to the detection result is lower than a preset cooling temperature, the controller is configured to control a power source to supply normal power to the heating module, and
wherein, when the temperature corresponding to the detection result is higher than or equal to the preset cooling temperature, the controller is configured to control the power source to reduce power supply to the heating module.

10. The electronic vaporizer of claim 7, wherein the controller is configured to start a heating program when the detection result matches a preset startup parameter.

11. The electronic vaporizer of claim 10, further comprising:
a plurality of first electrodes that are arranged at intervals; and
a plurality of second electrodes that are arranged at intervals,
wherein the plurality of first electrodes and the corresponding second electrodes are cooperatively configured to form equivalent capacitors at different positions on the aerosol-generation article, and
wherein the detection module is configured to detect dielectric constants at different positions on the aerosol-generation article by detecting capacitances of the equivalent capacitors at different positions.

12. A vaporization system, comprising:
an aerosol-generation article, comprising:
an aerosol-generation substrate; and
a temperature sensor comprising a dielectric material whose dielectric constant changes with a temperature,
wherein a Curie temperature of the dielectric material falls with a temperature range required by the aerosol-generation substrate for forming aerosols; and an electronic vaporizer, comprising:
a first electrode, a second electrode, a detection module, a controller, and a heating module,
wherein a cavity configured to accommodate an aerosol-generation article is formed between the first electrode and the second electrode,
wherein the detection module is configured to detect a dielectric constant of the aerosol-generation article accommodated in the cavity and feed back a detection result to the controller, and
wherein the controller is configured to control power supply to the heating module of the detection result,
wherein the electronic vaporizer is adapted to the aerosol-generation article.

13. A method for identifying a type of an aerosol-generation article, comprising:
detecting a dielectric constant of the aerosol-generation article; and
determining that the aerosol-generation article is of an identifiable type when a detection result matches a preset value.

14. The method of claim 13, wherein detecting the dielectric constant of the aerosol-generation article comprises:
detecting a parameter associated with the dielectric constant,
wherein the parameter comprises a capacitance value of an equivalent capacitor in which the aerosol-generation article is located or a resonance frequency of a resonance circuit in which the equivalent capacitor is located.

15. A device for identifying a type of an aerosol-generation article, comprising:
a third electrode;
a fourth electrode;
a measuring module; and
a main controller,
wherein an accommodating region configured to accommodate the aerosol-generation article is formed between the third electrode and the fourth electrode,
wherein the measuring module is configured to detect a dielectric constant of the aerosol-generation article arranged in the accommodating region and feed back a detection result to the main controller, and
wherein the main controller is configured to compare the detection result with a preset value and determine that the aerosol-generation article is of a type identifiable by the device when the detection result matches the preset value.

16. A temperature control method for an electronic vaporizer, comprising:
detecting a dielectric constant of an aerosol-generation article; and
adjusting a temperature of the aerosol-generation article according to a detection result.

17. The temperature control method of claim 16, wherein detecting a dielectric constant of an aerosol-generation article comprises:
detecting a parameter associated with the dielectric constant,
wherein the parameter comprises a capacitance value of an equivalent capacitor in which the aerosol-generation article is located or a resonance frequency of a resonance circuit in which the equivalent capacitor is located.
